(19) United States
(12) Patent Application Publication
(10) Pub. No.: US 2023/0163412 A1
(43) Pub. Date: May 25, 2023

(54) MANUFACTURING METHOD OF SEPARATOR FOR FUEL CELL, AND MANUFACTURING METHOD OF UNIT CELL FOR FUEL CELL

(71) Applicant: TOYOTA JIDOSHA KABUSHIKI KAISHA, Toyota-shi (JP)

(72) Inventors: Ryota SAKANOI, Toyota-shi (JP); Hiroomi KOBAYASHI, Okazaki-shi (JP); Atsuhiro MIURA, Nagoya-shi (JP)

(21) Appl. No.: 18/047,696

(22) Filed: Oct. 19, 2022

(30) Foreign Application Priority Data
Nov. 22, 2021 (JP) 2021-189175

(51) Int. Cl. H01M 50/403; H01M 50/46

(52) U.S. Cl. CPC H01M 50/403; H01M 50/461

(57) ABSTRACT

A manufacturing method includes a cleaning step of irradiating by laser light a joining site of a first separator to which a second separator is to be joined, without joining the first separator and the second separator. In the cleaning step, at least a part of a joining site is irradiated by the laser light such that a plurality of irradiation marks created by the laser light make up a separated irradiation mark pattern in which the irradiation marks are disposed separated from each other.

### CROSS-REFERENCE TO RELATED APPLICATION

This application claims priority to Japanese Patent Application No. 2021-189175 filed on Nov. 22, 2021, incorporated herein by reference in its entirety.

### BACKGROUND

### 1. Technical Field

The present disclosure relates to a manufacturing method of a separator for a fuel cell, and a manufacturing method of a unit cell for a fuel cell.

### 2. Description of Related Art

A fuel cell is made up by stacking a plurality of fuel-cell cells (unit cells) that each have a membrane electrode assembly (MEA) and two separators between which the MEA is interposed. The separator and another adjacent separator are joined to each other.

For example, in the technology described in Japanese Unexamined Patent Application Publication No. 2016-15310 (JP 2016-15310 A), separators adjacent to each other when unit cells are stacked are joined by laser welding. Prior to laser welding, a joining site and the surroundings thereof are irradiated by laser light (hereinafter referred to as “laser light for cleaning”), in order to remove adhering substances that are adhered to the joining site and the surroundings thereof. The reason is that when there are adhering substances that are adhered to the surface of the separators during joining by laser welding or the like, the quality of joining may deteriorate.

### SUMMARY

However, depending on the form of irradiation of the laser light for cleaning, the amount of heat input to the separator becomes excessively great, and the separators, which are thin plate-shaped members, are warped.

The present disclosure can be realized in the following aspects.

(1) According to an aspect of the present disclosure, a manufacturing method of a separator for a fuel cell is provided. This manufacturing method includes a cleaning step of irradiating by laser light a joining site of a first separator to which a second separator is to be joined, without joining the first separator and the second separator, and in the cleaning step, at least a part of the joining site is irradiated by the laser light such that a plurality of irradiation marks created by the laser light make up a separated irradiation mark pattern in which the irradiation marks are disposed separated from each other. According to this aspect, at least a part of the joining site is irradiated by laser light so as to make up a separated irradiation mark pattern, and accordingly sites that are irradiated by laser light and are affected by heat (heat-affected sites) can be reduced in comparison with when irradiation is performed such that a pattern is made up in which the irradiation marks are laid out without being separated from each other. That is to say, the amount of heat input to the separators due to laser irradiation can be reduced, and warpage of the separators due to the irradiation by the laser light can be suppressed.

(2) In the above aspect, the separated irradiation mark pattern may include a dotted pattern in which all the irradiation marks are disposed separated from each other. According to this form, in the dotted pattern, all the irradiation marks are disposed separated from each other, and accordingly the amount of heat input due to the laser irradiation to the separator can be suitably reduced.

(3) In the above aspect, in the separated irradiation mark pattern, the irradiation marks may be disposed equidistantly. According to this form, in the separated irradiation mark pattern, the irradiation marks are disposed equidistantly, and accordingly the cleaning by irradiation can be made uniform.

(4) In the above aspect, the separated irradiation mark pattern may include a row pattern containing a plurality of irradiation mark groups in which part of the irradiation marks that are adjacent are disposed overlapping each other, and the irradiation mark groups are disposed in row arrangements separated from each other. According to this form, the cleaning capability can be enhanced in the site of the irradiation mark group in which part of adjacent irradiation marks are disposed overlapping. The irradiation mark groups are separated from each other in rows, and accordingly the amount of heat input by laser irradiation to the separator can be reduced.

(5) In the above aspect, in the cleaning step, a first part of the joining site of the first separator may be irradiated by the laser light such that the row pattern is made up, the first separator making up a pair of separators included in a unit cell. The joining site may be a site at which the first separator and the second separator making up the pair of separators are to be joined. The first part of the joining site may be a part on which a force that separates the first separator and the second separator away from each other due to pressure of gas flowing through the unit cell acts more greatly than on other parts of the joining site. According to this form, a first part of the joining site on the separator surface on which a force that separates the separators making up a unit cell from each other due to effects of pressure of gas flowing through the unit cell acts more greatly than on other parts, may be irradiated by the cleaning laser such that the row pattern that is cleaned by a higher cleaning force than the dotted pattern is made up thereat. Accordingly, warpage of the separator can be reduced while maintaining the cleaning capability at sites where the peeling force exerts a large force on the separator, and thus maintaining joining strength.

(6) In the above aspect, in the cleaning step, irradiation by the laser light may be performed such that a direction in which the pressure of the gas acts and an array direction of the irradiation mark groups match each other in the row pattern. According to this form, separations between rows where the joining strength is lower than at the sites where the irradiation marks are created are not continuous in the direction in which the gas pressure acts, and thus the joining strength can be enhanced with respect to the input of gas pressure, in comparison with when the direction in which the gas pressure acts and the array direction of the irradiation mark group of the row pattern are orthogonal, for example.

(7) In the above aspect, the separator may have a refrigerant outlet hole passing through the separator, and in the cleaning step, a second part of the joining site of the first separator may be irradiated by the laser light such that the row pattern is made up. The joining site may be a site at which the first separator and the second separator making up a unit cell along with the first separator are to be joined. The second part of the joining site may be a part situated at a perimeter of the refrigerant outlet hole.

According to this form, when the separator makes up a unit cell, the cleaning site situated on the perimeter of the refrigerant outlet hole which is a second part of the joining site on which a force that peels the two separators away from each other due to effects of pressure of gas is greater than at other parts on the separator surface, may be irradiated by the cleaning laser such that the row pattern that is cleaned by a higher cleaning force than the dotted pattern is made up thereat. Accordingly, at the cleaning site situated on the perimeter of the refrigerant outlet hole, warpage of the separator can be reduced while maintaining the cleaning capability, and thus maintain the joining strength.

(8) In the above aspect, the separator may further include a refrigerant inlet hole passing through the separator, and a channel groove fashioned extending from the refrigerant inlet hole toward a side of the refrigerant outlet hole, and in the cleaning step, irradiation by the laser light may be performed such that a direction in which the channel groove extends and the array direction of the irradiation mark groups match each other in the row pattern.

The direction in which the channel groove extends substantially matches with the direction in which the pressure of the gas flowing inside the unit cell acts when the separator makes up a unit cell. According to this form, separations between rows where the joining strength is lower than at the sites where the irradiation marks are created are not continuous in the direction in which the gas pressure acts, and thus the joining strength can be enhanced with respect to the input of gas pressure, in comparison with when the direction in which the gas pressure acts and the array direction of the irradiation mark group of the row pattern are orthogonal, for example.

(9) According to another aspect of the present disclosure, a manufacturing method of a unit cell for a fuel cell is provided. The manufacturing method of a separator for a fuel cell includes a separator manufacturing step of manufacturing a separator by the manufacturing method according to the above aspect, a separator preparing step of preparing a plurality of the separators manufactured by the separator manufacturing step, an adhesive sheet member installing step of interposing a thermoplastic adhesive sheet member between the separators prepared in the separator preparing step, and a thermocompression bonding step of joining the separators stacked by interposing the thermoplastic adhesive sheet member between the separators in the adhesive sheet member installing step, by thermocompression bonding. According to this aspect, in the manufacturing, a separator can be manufactured in which warpage of the separator due to irradiation of laser light is suppressed. Further, by going through the preparing of the separator, the installing of the adhesive sheet member, and the thermocompression bonding, a unit cell for a fuel cell that uses the thermoplastic adhesive sheet member can be suitably manufactured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a schematic configuration of a fuel cell to which separators, manufactured by a manufacturing method of a fuel cell separator according to a first embodiment of the present disclosure, are applied;

FIG. 2 is a plan view illustrating a separator manufactured by the manufacturing method of a separator according to the first embodiment;

FIG. 3 is a flowchart showing procedures of the manufacturing method of a separator for a fuel cell;

FIG. 4 is a diagram schematically illustrating a dotted pattern;

FIG. 5 is a diagram schematically illustrating a row pattern;

FIG. 6 is a diagram illustrating a heat-affected range due to being subjected to laser irradiation processing;

FIG. 7 is a diagram illustrating an example of an irradiation mark pattern in a comparative form; and

FIG. 8 is a flowchart showing procedures in a manufacturing method of a unit cell for a fuel cell.

### DETAILED DESCRIPTION OF EMBODIMENTS

### A. First Embodiment

A1. Overall Configuration of Fuel Cell

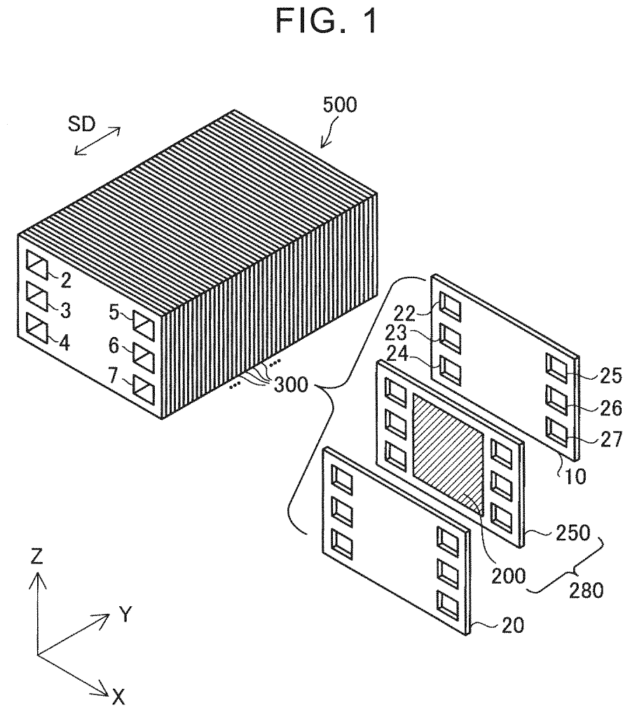

FIG. 1 is a perspective view illustrating a schematic configuration of a fuel cell 500 to which separators 10 and 20, manufactured by a manufacturing method of a fuel cell separator according to a first embodiment of the present disclosure, are applied. Note that in FIG. 1, surfaces of the separators 10 and 20 are illustrated partially simplified. The fuel cell 500 is formed by stacking a plurality of fuel cell unit cells 300 (hereinafter, also simply referred to as “unit cell 300”) in a stacking direction SD. Hereinafter, an X-axis and a Y-axis are parallel to a lateral plane, and a Z-axis is parallel to a vertical direction. A+Z direction indicates vertically upward, and a −Z direction indicates vertically downward. In the present embodiment, the stacking direction SD is a direction parallel to the Y-axis. In the present embodiment, the unit cell 300 is a solid polymer fuel cell. Six manifolds 2 to 7 are formed inside the fuel cell 500.

An oxidant gas supply manifold 2 supplies air, which is an oxidant gas, to each unit cell 300. A cooling medium supply manifold 3 supplies a cooling medium to each unit cell 300. A fuel gas discharge manifold 4 discharges the fuel gas discharged from each unit cell 300 to the outside of the fuel cell 500. A fuel gas supply manifold 5 supplies hydrogen gas, which is a fuel gas, to each unit cell 300. A cooling medium discharge manifold 6 discharges the cooling medium discharged from each unit cell 300 to outside of the fuel cell 500. An oxidant gas discharge manifold 7 discharges the oxidant gas discharged from each unit cell 300 to the outside of the fuel cell 500. All six of the manifolds 2 to 7 extend in parallel with the stacking direction SD.

Each unit cell 300 includes a Membrane Electrode and Gas diffusion layer Assembly (MEGA) plate 280 and a pair of separators, which are a first separator 10 and a second separator 20, and which are disposed so as to interpose the MEGA plate 280 therebetween in the stacking direction. Hereinafter, the first separator 10 and the second separator 20 may be referred to simply as “separators 10 and 20”, when not distinguished in particular.

The MEGA plate 280 includes a MEGA 200 and a support frame 250. The MEGA 200 has a configuration in which a solid polymer electrolyte membrane, an anode-side catalyst electrode layer, a cathode-side catalyst electrode layer, an anode-side gas diffusion layer, and a cathode-side gas diffusion layer are stacked in the stacking direction SD. A through hole is provided in a middle portion of the support frame 250 in a thickness direction (Y-axis direction), and the MEGA 200 is disposed in the through hole. Note that the support frame 250 is made of a thermoplastic adhesive sheet, and the MEGA plate 280 corresponds to a “thermoplastic adhesive sheet member”.

A2. Configuration of Separator

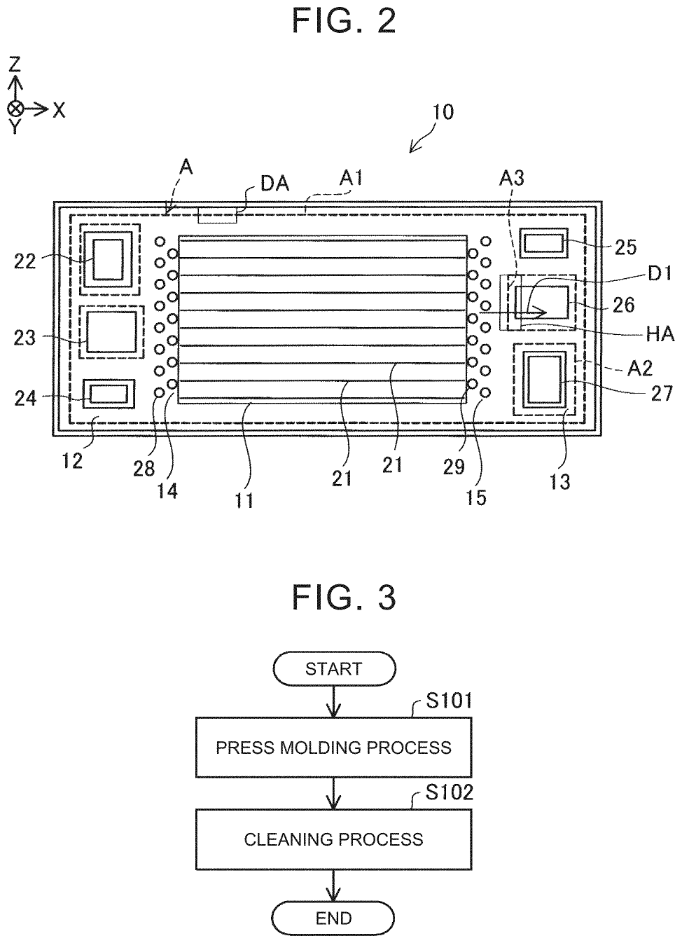

Next, the configurations of the separators 10 and 20 will be described. The separators 10 and 20 are thin plate members each having a substantially rectangular shape, and protruding and recessed shapes are formed on both sides thereof in the stacking direction SD. These protruding and recessed shapes form in-cell gas flow channels through which reactive gas (fuel gas or oxidant gas) flows. FIG. 2 is a plan view illustrating the first separator 10 manufactured by the manufacturing method of the separator according to the first embodiment. FIG. 2 illustrates, of both faces of the first separator 10, the face facing the MEGA plate 280. The shape of the second separator 20 and the shape of the first separator 10 are in a plane-symmetrical relation. Accordingly, the first separator 10 will be described representatively.

As illustrated in FIG. 2, the first separator 10 has a power generation reaction portion 11, a first manifold portion 12, a second manifold portion 13, an inlet buffer portion 14, and an outlet buffer portion 15. The power generation reaction portion 11 is situated at a substantially middle position in an X direction, and is situated between the first manifold portion 12 and the second manifold portion 13. The power generation reaction portion 11 has a plurality of channel grooves 21 extending linearly in the X direction.

The first manifold portion 12 is situated at an edge portion in a −X direction. The first manifold portion 12 has an oxidant gas inlet hole 22, a refrigerant inlet hole 23, and a fuel gas outlet hole 24. These holes 22, 23, and 24 each pass through the separator 10 in a Y direction, and are formed in this order in the −Z direction.

The second manifold portion 13 is situated at an edge portion in a +X direction. The second manifold portion 13 has a fuel gas inlet hole 25, a refrigerant outlet hole 26, and an oxidant gas outlet hole 27. These holes 25, 26, and 27 each pass through the separator 10 in the Y direction, and are formed in this order in the −Z direction. When the fuel cell 500 is assembled by stacking the unit cells 300, the holes 22 to 27 are overlaid in the stacking direction SD to form the above-described six manifolds 2 to 7.

The inlet buffer portion 14 has a plurality of embossed portions 28, and is provided between the first manifold portion 12 and the power generation reaction portion 11. The outlet buffer portion 15 has a plurality of embossed portions 29, and is provided between the second manifold portion 13 and the power generation reaction portion 11.

The channel grooves 21 of the first separator 10 function as a channels through which the oxidant gas flows from the oxidant gas inlet hole 22 to the oxidant gas outlet hole 27. Channel grooves that are omitted from illustration are similarly formed on a rear face of the first separator 10, and the channel grooves function as a refrigerant channels through which the refrigerant flows from the refrigerant inlet hole 23 to the refrigerant outlet hole 26. Similar to the first separator 10, the second separator 20 is formed with channel grooves on both the front and rear faces, and one of the channel grooves functions as refrigerant channels, as with the channel grooves 21. The other of the channel grooves function as fuel gas channels for fuel gas to flow from the fuel gas inlet hole 25 to the fuel gas outlet hole 24.

A3. Separator Manufacturing Method

Next, a manufacturing method of the separators 10 and 20 will be described. FIG. 3 is a flowchart showing procedures of the manufacturing method of the fuel cell separators 10 and 20 according to the first embodiment. As shown in FIG. 3, in the manufacturing method of the fuel cell separators 10 and 20, first, a press molding process is executed in step S101 (hereinafter, “step” will be abbreviated to “S”), and subsequently, a cleaning process is performed in S102. In the press molding process (S101), outer shapes of the separators 10 and 20 having the holes 22 to 27 and the channel grooves 21, described above, are formed by press molding.

In the cleaning process (S102), joining surfaces of the separators 10 and 20 to be joined to each other to form the unit cell 300, i.e., the surfaces on the sides where the separators 10 and 20 face the MEGA plate 280, are irradiated by laser light for cleaning. In FIG. 2, a cleaning site A, which is a portion to be laser-cleaned in the cleaning process (S102), is indicated by dashed lines. Further, the cleaning site A corresponds to a joining site for joining the first separator 10 and the second separator 20, the “joining site” and the “cleaning site” being substantially the same site.

In the cleaning process (S102), a separator (first separator 10 making up a certain unit cell 300) is irradiated by laser light without being joined to the joining site of another separator (second separator 20 making up the certain unit cell 300) which is to be paired with the separator to make up the certain unit cell 300 together.

As illustrated in FIG. 2, the cleaning site A includes an outer peripheral cleaning site A1 along the vicinity of an outer peripheral edge of the separator 10, and hole peripheral cleaning sites A2 that surround around the oxidant gas inlet hole 22, around the refrigerant inlet hole 23, around the refrigerant outlet hole 26, and around the oxidant gas outlet hole 27. A hole peripheral cleaning site A2 situated at a perimeter of the refrigerant outlet hole 26 and a second part of the joining site are substantially the same site.

As a method of joining the separators 10 and 20, in the present embodiment, a method of interposing the MEGA plate 280 between the separators 10 and 20, and performing hot pressing on the joining sites to perform thermoplastic joining is employed. When adhering substance are adhering to the surfaces of the separators 10 and 20 at the time of this joining, the joining quality may deteriorate. Accordingly, prior to the joining process, a cleaning process of irradiating the joining site by cleaning laser light is performed in order to remove the adhering substances that are adhered to the joining site. Details of the manufacturing method of the unit cell 300, including the process of joining the separators 10 and 20 using the above MEGA plate 280 serving as a thermoplastic adhesive sheet member, will be described later.

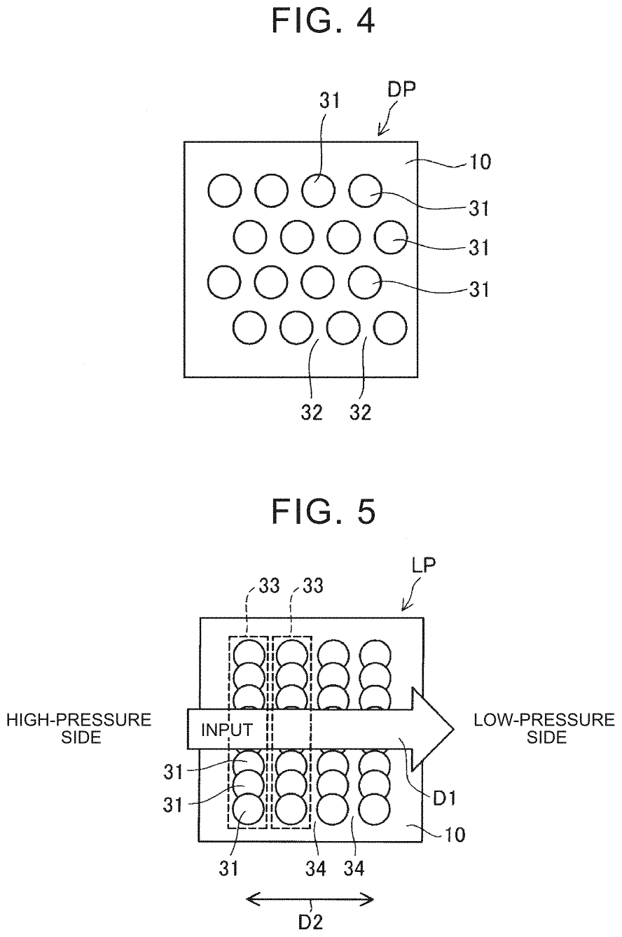

In the cleaning process (S102) according to the present embodiment, the cleaning site A is subjected to irradiation by the cleaning laser light, such that a plurality of irradiation marks 31 (see FIGS. 4 and 5) formed by the cleaning laser light are disposed separated from each other, making up a separated irradiation mark pattern. The separated irradiation mark pattern has two patterns, a dotted pattern DP and a row pattern LP. The dotted pattern DP and the row pattern LP differ in the forms in which the irradiation marks 31 are formed.

FIG. 4 is a diagram schematically illustrating the dotted pattern DP. As illustrated in FIG. 4, in the dotted pattern DP, all the irradiation marks 31 having circular shapes are separated from each other and disposed equidistantly. Predetermined gaps 32 are formed between the adjacent irradiation marks 31. FIG. 5 is a diagram schematically illustrating the row pattern LP. As illustrated in FIG. 5, the row pattern LP has a plurality of irradiation mark groups 33 in which adjacent irradiation marks 31 having circular shapes are disposed partially overlapping each other, and the irradiation mark groups 33 are disposed as rows separated from each other. Predetermined gaps 34 are formed between the adjacent irradiation mark groups 33. Note that while the irradiation marks 31 are schematically illustrated as being precise circles in FIGS. 4 and 5, the shape is not a precise circle but actually is rather a shape close to an ellipse, for example, depending on the specifications of the laser beam that is used. Also, the diameter of each of the irradiation marks 31 is, for example, about 100 μm to 150 μm.

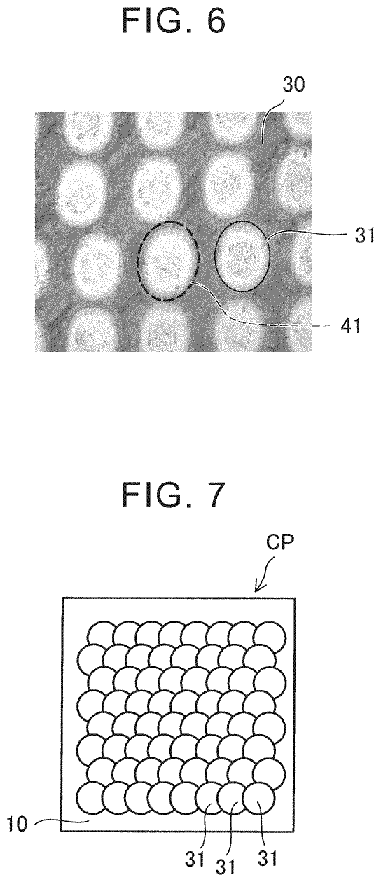

FIG. 6 is a diagram illustrating a heat-affected range 41 when subjected to laser irradiation processing, and is a photograph showing the surface of a black-stained experimental separator 30 following laser cleaning processing thereof. In FIG. 6, an irradiation mark 31 is illustrated surrounded by a thin continuous line, and a heat-affected range 41, which is affected by heat by the laser irradiation, is illustrated surrounded by a dashed line. As shown in FIG. 6, black staining is not removed in the portion outside the heat-affected range 41, but the heat-affected range 41 is larger than the irradiation mark 31 and extends beyond the outside of the irradiation mark 31, and accordingly impurities can be removed within the heat-affected range 41.

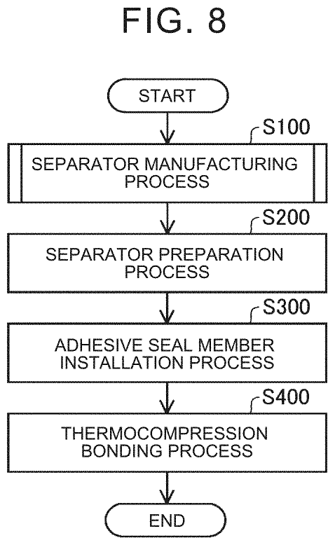

FIG. 7 is a diagram illustrating an example of an irradiation mark pattern CP in a comparative form. As illustrated in FIG. 7, in the comparative form, the irradiation mark pattern CP is formed in which the irradiation marks 31 are laid out without gaps. Adhering substances can still be removed even if the irradiation marks 31 are separated by a predetermined distance and formed at intervals as in the separated irradiation mark pattern according to the present embodiment, even without using such an irradiation mark pattern CP.

In the above-described dotted pattern DP and row pattern LP, gaps 32 and 34 are formed between the irradiation marks 31 or between the irradiation mark groups 33, with the gaps 32 and 34 being set so as to be within the heat-affected range 41 and accordingly adhering substances can be removed from the gaps 32 and 34 as well. While the diameter and spacing of the irradiation marks 31 can be changed as appropriate, the diameter and the spacing are identified and set in advance by experimentation and so forth, as values of a level that satisfy predetermined threshold values regarding the range covered by the heat-affected range 41. Further, the row pattern LP is formed by the irradiation marks 31 partially overlapping in one direction (the up-down direction as illustrated in FIG. 5), and due to the area irradiated by the laser being greater than that of the dotted pattern DP, cleaning capability by laser irradiation is higher.

In the cleaning process (S102) in the manufacturing method of the separator according to the first embodiment, cleaning is performed regarding, out of the hole peripheral cleaning sites A2, a cleaning site around the refrigerant outlet hole 26 that is situated on the −X direction side and extends in the Z direction (hereinafter, referred to as “high input site A3” (see FIG. 2)), so as to make up a row pattern LP. The high input site A3 is a site being cleaned and situated in a high input region HA in FIG. 2, and the high input site A3 and a first part of the joining site are substantially the same site. The other joining sites (sites illustrated as joining portions DA, for example, in FIG. 2) are cleaned so as to make up a dotted pattern DP.

In the configuration in which the separators 10 and 20 are stacked to form the unit cells 300 and the unit cells 300 are further stacked to form the fuel cell 500, the high input region HA is a site at which force acting to peel the two separators 10 and 20 away from each other is greater than at other sites of the joining surfaces of the separators 10 and 20, due to the pressure of the reactive gas flowing through the unit cells 300 thereat. Accordingly, the high input site A3, which is a cleaning site situated in the high input region HA, is subjected to laser cleaning to make up the row pattern LP, of which cleaning capability is high, so that joining strength can be increased by removing the adhering substance more reliably.

Further, in the first embodiment, as illustrated in FIG. 5, irradiation by laser is performed so that a direction D1 in which the gas pressure acts and an array direction D2 of the irradiation mark groups 33 of the row pattern LP match each other. The array direction D2 is a direction that intersects (orthogonally in the present embodiment) the direction in which the irradiation mark groups 33 extend linearly. By matching the direction D1 in which the gas pressure acts with the array direction D2 of the irradiation mark groups 33, the irradiation marks 31 and the gaps 34 between the rows of the irradiation mark groups 33 are alternatingly formed in the direction D1 in which the gas pressure acts.

Note that the “direction D1 in which the gas pressure acts” and the “direction in which the channel grooves 21 extend” are substantially the same. The irradiation marks 31 are disposed in rows without gaps in the direction orthogonal to the direction D1 in which the gas pressure acts, and accordingly resistance to the gas pressure can be improved.

Adjustment of irradiation mark patterns is performed by a known laser welding device. A laser light emitting unit that the laser welding device is provided with moves over lines in the cleaning site A, while emitting the laser light. A light emitting unit actuator moves the laser light emitting unit so as to make up the irradiation mark patterns based on instructions of a control unit.

In the dotted pattern DP, the irradiation is turned off every other irradiation in the scanning direction and the feed direction of the laser light emitting unit. In the row pattern LP, when forming one irradiation mark group 33, the laser light emitting unit is scanned so that the irradiation marks 31 overlap in the scanning direction of the laser light emitting unit, and then the irradiation mark group 33 of the next row is formed in the same manner as described above, after turning off the irradiation in the feed direction of the laser emitting unit such that the gap 34 is formed therebetween. The irradiation mark patterns may be adjusted by a laser device provided with a galvanometer scanner capable of scanning the laser in two-dimensional directions by changing the reflection direction of the laser.

A4. Manufacturing Method of Unit Cell

Next, a manufacturing method of the unit cell 300 will be described with reference to FIG. 8. FIG. 8 is a flowchart showing procedures in the manufacturing method of the unit cell 300. As shown in FIG. 8, the manufacturing method of the unit cell 300 includes a separator manufacturing process (S100), a separator preparation process (S200), an adhesive sheet member installation process (S300), and a thermocompression bonding process (S400), in the order of execution.

In the separator manufacturing process (S100), the first separator 10 and the second separator 20 are manufactured by the above-described separator manufacturing method. In the separator preparation process (S200), the first separator 10 and the second separator 20 manufactured in the separator manufacturing process (S100) are prepared. In the adhesive seal member installation process (S300), the MEGA plate 280 (thermoplastic adhesive sheet member) is interposed between the first separator 10 and the second separator 20, and installed. In the thermocompression bonding process (S400), the separators 10 and 20 stacked with the MEGA plate 280 (thermoplastic adhesive sheet member) interposed therebetween are joined by thermocompression bonding. Thus, the unit cell 300 is manufactured.

(1)

In the manufacturing method of the separators 10 and 20 according to the first embodiment, in the cleaning process (S102), irradiation by cleaning laser light is performed for the cleaning site A such that the irradiation marks 31 are disposed separated from each other, so as to make up a separated irradiation mark pattern. Accordingly, regions affected by heat by being irradiated by the laser light can be reduced in comparison with when irradiating with the irradiation mark pattern CP (see FIG. 7) in which the irradiation marks 31 are laid out without being separated from each other.

That is to say, the amount of heat input to the separators 10 and 20 due to laser irradiation can be reduced, and warpage of the separators 10 and 20 due to the irradiation by the cleaning laser light can be suppressed. In a situation in which the separators 10 and 20 are warped, there is a risk that the separators 10 and 20 may be improperly transported such as interfering with a jig or the like in a transporting process, and joining defects or the like may occur, but such trouble can be avoided.

(2)

In the manufacturing method of the separators 10 and 20 according to the first embodiment, irradiation by the cleaning laser is performed so as to make up the row pattern LP that is cleaned with a higher cleaning power than the dotted pattern DP at the high input site A3, which is where the force acting to peel the joining of the separators 10 and 20 away from each other is great when configured as the unit cell 300 for a fuel cell. Accordingly, adhering substances in the high input site A3 can be removed more reliably, and the joining strength in the subsequent joining process can be enhanced.

(3)

Also, in the manufacturing method of the separators 10 and 20 according to the first embodiment, the outer peripheral cleaning site A1 regarding which relatively low strength is allowable is irradiated by a cleaning laser so as to make up the dotted pattern DP. That is to say, by appropriately using a plurality of separated irradiation mark patterns having different cleaning capabilities (and thus different bonding strengths) in accordance with the strength respectively required for a plurality of the cleaning sites, warpage of the separators 10 and 20 can be suitably reduced, while maintaining joining strength at sites requiring strength.

(4)

Further, the high input site A3 is subjected to irradiation by laser so that the direction D1 in which the gas pressure acts and the array direction D2 of the irradiation mark groups 33 of the row pattern LP match each other. Accordingly, the gaps 34 between the rows having a lower bonding strength than the sites where the irradiation marks 31 are formed are not continuous in the direction D1 in which the gas pressure acts, and thus the joining strength can be enhanced with respect to the input of gas pressure, in comparison with when the direction D1 in which the gas pressure acts and the array direction D2 of the irradiation mark groups 33 of the row pattern LP are orthogonal, for example.

### B. Other Embodiments

(B1)

In the first embodiment above, the irradiation marks 31 in the dotted pattern DP are disposed at equal intervals, but the irradiation marks 31 do not have to be equidistantly spaced, as long as the heat-affected range 41 can be achieved as desired. Also, the intervals of the irradiation mark groups 33 in the row pattern LP do not have to be equidistantly spaced, either.

(B2)

In the first embodiment above, the cleaning site A includes the outer peripheral cleaning site A1 and the hole peripheral cleaning sites A2, but the cleaning site A (joining site) is not limited to this form, and can be changed as appropriate, in accordance with the product specifications of the separators 10 and 20.

(B3)

In the first embodiment above, the separated irradiation mark patterns include the dotted pattern DP and the row pattern LP, but may include just one of these, or other patterns in which the irradiation marks 31 are disposed separated from each other may be used.

(B4)

In the first embodiment above, the irradiation by laser is performed on the entirety of the cleaning site A so as to make up separated irradiation mark patterns, but at least a part of the cleaning site A may be provided with separated irradiation mark patterns. For example, an arrangement may be made in which the high input site A3 where strength is required is irradiated so as to make up the irradiation mark pattern CP, in which the irradiation marks 31 are laid out as illustrated in FIG. 7 as a comparative form, and the other cleaning sites A1 and A2 are irradiated so that separated irradiation mark patterns are formed. Further, the way in which the dotted pattern DP and the row pattern LP are used for the cleaning sites may be changed as appropriate. For example, an arrangement may be made in which all hole peripheral cleaning sites A2 including the high input site A3 are irradiated so as to make up the row patterns LP, and the outer peripheral cleaning site A1 is irradiated so as to make up dotted patterns DP.

(B5)

In the manufacturing method of the separator according to the first embodiment, a manufacturing method has been described in which the cleaning process (S102) is carried out as preprocessing for joining the joining faces of the separators 10 and 20 that are thermoplastically joined using the MEGA plate 280 as a thermoplastic adhesive sheet member, i.e., for joining the inner face sides of the unit cell 300 of the separators 10 and 20 making up one unit cell 300. Alternatively, a manufacturing method may be used in which, for example, a cleaning process is performed as preprocessing when outer face sides of unit cells 300 are joined by welding.

The present disclosure is not limited to the embodiments above, and can be realized by various configurations without departing from the essence thereof. For example, the technical features of the embodiments corresponding to the technical features in each aspect described in the section of the summary of the disclosure may be replaced or combined appropriately to solve part or all of the above issues or to achieve part or all of the above effects. When the technical features are not described as essential in this specification, such technical features can be omitted as appropriate.

What is claimed is:

1. A manufacturing method of a separator for a fuel cell, the manufacturing method comprising:
a cleaning step of irradiating by laser light a joining site of a first separator to which a second separator is to be joined, without joining the first separator and the second separator, wherein
in the cleaning step, at least a part of the joining site is irradiated by the laser light such that a plurality of irradiation marks created by the laser light make up a separated irradiation mark pattern in which the irradiation marks are disposed separated from each other.

2. The manufacturing method according to claim 1, wherein the separated irradiation mark pattern includes a dotted pattern in which all the irradiation marks are disposed separated from each other.

3. The manufacturing method according to claim 2, wherein, in the separated irradiation mark pattern, the irradiation marks are disposed equidistantly.

4. The manufacturing method according to claim 1, wherein the separated irradiation mark pattern includes a row pattern containing a plurality of irradiation mark groups in which part of the irradiation marks that are adjacent are disposed overlapping each other, and the irradiation mark groups are disposed in row arrangements separated from each other.

5. The manufacturing method according to claim 4, wherein, in the cleaning step, a first part of the joining site of the first separator is irradiated by the laser light such that the row pattern is made up, the first separator making up a pair of separators included in a unit cell;
the joining site is a site at which the first separator and the second separator making up the pair of separators are to be joined; and
the first part of the joining site is a part on which a force that separates the first separator and the second separator away from each other due to pressure of gas flowing through the unit cell acts more greatly than on other parts of the joining site.

6. The manufacturing method according to claim 5, wherein, in the cleaning step, irradiation by the laser light is performed such that a direction in which the pressure of the gas acts and an array direction of the irradiation mark groups match each other in the row pattern.

7. The manufacturing method according to claim 4, wherein
the separator has a refrigerant outlet hole passing through the separator;
in the cleaning step, a second part of the joining site of the first separator is irradiated by the laser light such that the row pattern is made up;
the joining site is a site at which the first separator and the second separator making up a unit cell along with the first separator are to be joined; and
the second part of the joining site is a part situated at a perimeter of the refrigerant outlet hole.

8. The manufacturing method according to claim 7, wherein
the separator further includes a refrigerant inlet hole passing through the separator, and a channel groove fashioned extending from the refrigerant inlet hole toward a side of the refrigerant outlet hole, and
in the cleaning step, irradiation by the laser light is performed such that a direction in which the channel groove extends and an array direction of the irradiation mark groups match each other in the row pattern.

9. A manufacturing method of a unit cell for a fuel cell, the manufacturing method comprising:
a separator manufacturing step of manufacturing a separator by the manufacturing method according to claim 1;
a separator preparing step of preparing a plurality of the separators manufactured by the separator manufacturing step;
an adhesive sheet member installing step of interposing a thermoplastic adhesive sheet member between the separators prepared in the separator preparing step; and
a thermocompression bonding step of joining the separators stacked by interposing the thermoplastic adhesive sheet member between the separators in the adhesive sheet member installing step, by thermocompression bonding.
